(19) United States
(12) Patent Application Publication
(10) Pub. No.: US 2008/0282752 A1
(43) Pub. Date: Nov. 20, 2008

(54) Method and Apparatus for Assisting in the Application and Removal of Handcuffs

(76) Inventor: Jason Peter Owens, New South Wales (AU)

Correspondence Address: LADAS & PARRY LLP, 26 WEST 61ST STREET, NEW YORK, NY, 10023, US

(21) Appl. No.: 11/663,821

(22) PCT Filed: Oct. 4, 2005
(86) PCT No.: PCT/AU05/01508

§ 371 Date: Apr. 24, 2008

(30) Foreign Application Priority Data
Oct. 12, 2004 (AU) 2004905888

(51) Int. Cl. E05B 75/00

(52) U.S. Cl. 70/16

(57) ABSTRACT

An apparatus (20) for assisting in the application and removal of handcuffs. The handcuffs including two cuffs joined by a central portion. The apparatus (20) comprises a base (22) adapted for stationary fixing, a switch (40) and a means (36) to selectively restrain the central portion of the handcuffs relative to the base within an opening (30) through which the cuffs cannot pass, in response to activation of the switch (40).

### FIELD OF THE INVENTION

The present invention relates to a method and apparatus for assisting in the application and removal of handcuffs.

### BACKGROUND OF THE INVENTION

Numerous different styles of handcuffs are available for restraining the wrists of detainees for law enforcement purposes. The two main styles of handcuffs are chained and hinged, which refer to how the two cuffs are joined.

Among the various handcuffs available, the physical dimensions and characteristics vary greatly on account of numerous features including different metal plate thicknesses, different weight characteristics and ergonomic shape considerations.

Whilst a detainee is being released from handcuffs, a law enforcement officer is at risk of being injured after one of the detainee's hands has been released, as the detainee is then able to move both arms independently.

When applying handcuffs to a detainee, law enforcement officers are also at risk of being injured if the detainee resists arrest.

Also, absent some other restraint, when a detainees wrists are not secured to each other during handcuff application or removal, the detainee is able to independently use both hands to attempt escape.

### OBJECT OF THE INVENTION

It is an object of the present invention to overcome or ameliorate one or more of the above disadvantages, or at least to provide a useful alternative.

### SUMMARY OF THE INVENTION

In a first aspect, the present invention provides an apparatus for assisting in the application and removal of handcuffs, the handcuffs including two cuffs joined by a central portion, the apparatus comprising:

a base adapted for stationary fixing;

a switch; and

a means to selectively restrain the central portion of the handcuffs relative to the base within an opening through which the cuffs cannot pass, in response to activation of the switch.

Preferably, the switch is associated with the base.

The apparatus preferably includes an adjustment means adapted to selectively alter the size of the opening, thereby accommodating different sized handcuffs.

The restraint means preferably includes a recess formed in the base. The recess is preferably a slot.

The restraint means preferably includes a pin transversely extendable across the slot.

The adjustment means is preferably adapted to alter the distance between the bottom of the slot and the pin.

The adjustment means is preferably a spring biased plate.

The adjustment means preferably includes a screw extendable into a hole in the bottom of the slot, the screw being engagable with a fastener inside the base.

Preferably, the switch is a foot pedal. The switch is preferably in electrical communication with the restraint means.

The switch is preferably shielded on one or more sides by a shield member.

The base is preferably an elongate tube.

The tube is preferably connectable at a first end to a base plate, and the restraint means is located at a second end of the tube.

The base plate preferably includes a number of apertures adapted to receive fasteners for securing the apparatus.

The base preferably has an internal cavity housing a bar, the bar mechanically connecting the foot pedal to the restraint means.

The bar is spring biased to close the restraint means when no force is applied to the pedal.

In a second aspect, the present invention provides a method of applying handcuffs to a person, the handcuffs including two cuffs joined by a central portion, the method including the steps of:

placing the central portion in an opening of a fixed apparatus;

restricting the opening such that the central portion is restrained therein;

placing one of the person's wrists in one of the cuffs and locking the cuff; and

placing the person's other wrist in the other cuff and locking that cuff.

In a third aspect, the present invention provides a method of removing handcuffs from a person, the handcuffs including two cuffs joined by a central portion, the method including the steps of:

placing the central portion in an opening of a fixed apparatus;

restricting the opening such that the central portion is restrained therein;

unlocking one of the cuffs and thereby releasing one of the person's wrists; and

unlocking the other cuff and thereby releasing the person's other wrist.

The method preferably includes the step of adjusting the size of the opening to correspond to the size of the central portion of the handcuffs.

### BRIEF DESCRIPTION OF THE DRAWINGS

A preferred embodiment of the invention will now be described, by way of example only, with reference to the accompanying drawings in which:

FIG. 1 is a front view of a first embodiment of an apparatus for assisting in the application and removal of handcuffs according to the invention;

FIG. 2 is a top view of the base plate of the apparatus shown in FIG. 1;

FIG. 3 is a partial side view of the apparatus shown in FIG. 1;

FIG. 4 is a top view of a head plate of the apparatus shown in FIG. 1;

FIG. 5 is a front view of a head cover of the apparatus shown in FIG. 1;

FIG. 6 is a side view of the head cover shown in FIG. 5;

FIG. 7 shows an inner bar and spring of the apparatus shown in FIG. 1;

FIG. 8 is a top view of a pedal of the apparatus shown in FIG. 1;

FIG. 9 is a side view of the pedal shown in FIG. 8;

FIG. 10 shows a pedal lever of the apparatus shown in FIG. 1;

FIG. 11 is a side view of a head of the apparatus shown in FIG. 1;

FIG. 12 is a front view of the head shown in FIG. 11;

FIG. 13 is a top view of the head shown in FIGS. 11 and 12;

FIG. 14 is a bottom view of the head shown in FIGS. 11 to 13;

FIG. 15 shows a locking pin of the apparatus shown in FIG. 1;

FIG. 16 shows a top view of a head spacer of the apparatus shown in FIG. 1;

FIG. 17 shows a side view of the head spacer shown in FIG. 16;

FIG. 18 shows a front view of the pedal shield;

FIG. 19 shows a side view of the pedal shield shown in FIG. 18;

FIG. 20 is a front view of a second embodiment of an apparatus for assisting in the application and removal of handcuffs according to the invention;

FIG. 21 is a front view of a head cover shown in FIG. 20; and

FIG. 22 is a side view of the cover shown in FIG. 21.

### DETAILED DESCRIPTION OF THE PREFERRED EMBODIMENTS

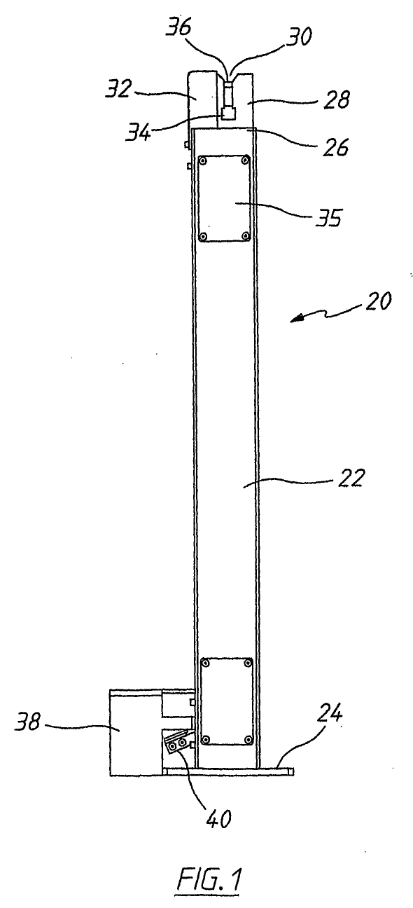

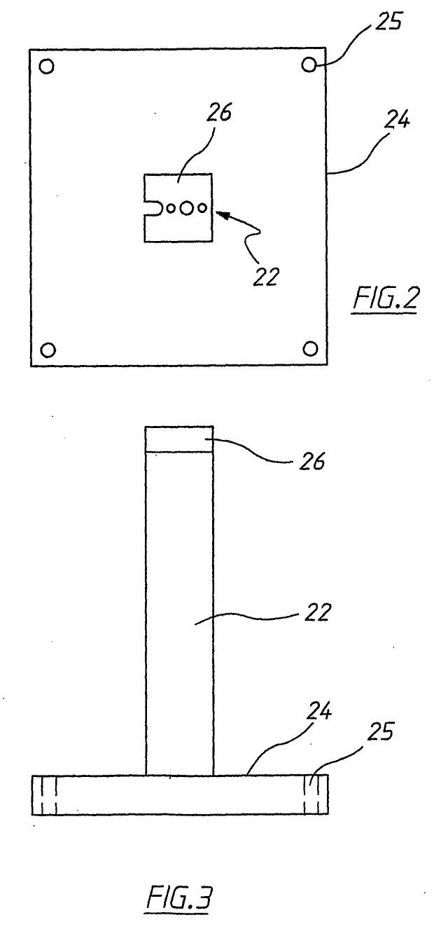

FIG. 1 shows a front view of a first embodiment of an apparatus for assisting in the application and removal of handcuffs, generally indicated by the reference numeral 20. The apparatus 20 includes a base 22 made from square metal tubing. As best seen in FIG. 2, the base 22 is connected at its lower end to a flanged base plate 24. The base plate 24 has holes 25 for securing the apparatus 20, to for example, a floor by expanding bolts (not shown) or the like.

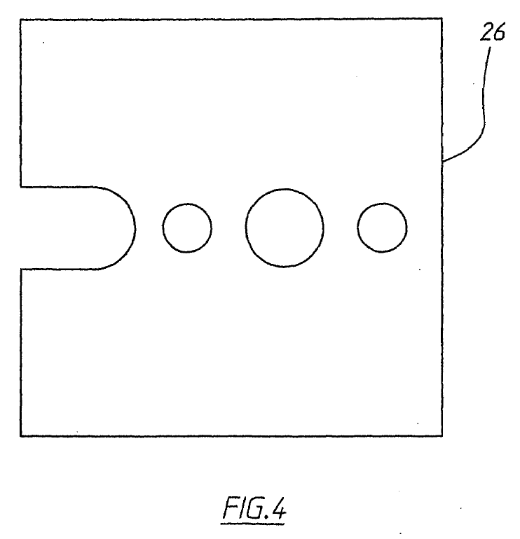

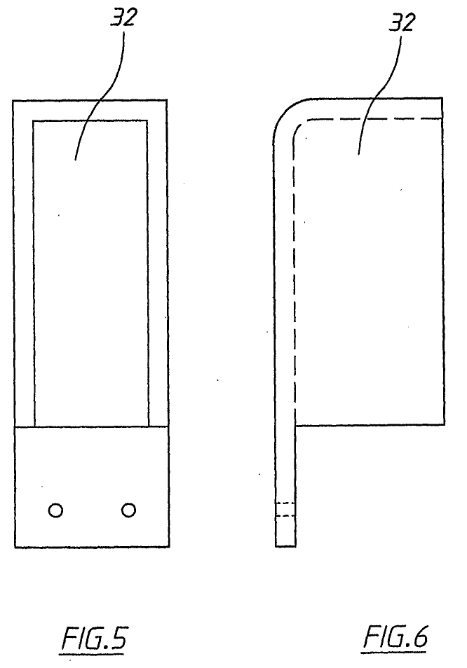

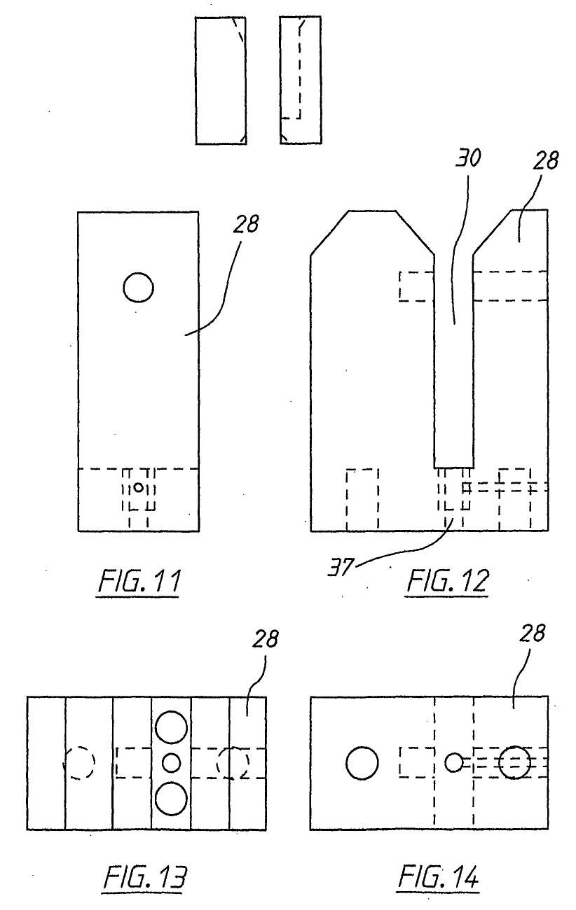

FIG. 4 shows a head plate 26 connected to the upper end of the base 22. The head plate 26 is connected to and supports a head 28, which is shown in detail in FIGS. 11 to 14. The head 28 includes an opening, in the form of a vertical slot 30, which extends downwardly from the top surface of the head 28. A head cover 32 (see FIGS. 5 and 6) is attached to the side of the head 28, and covers the internal cavity formed inside the tubular base 22.

The head 28 is vertically positioned above the ground at a suitable height corresponding to the height of the wrists of a typical detainee standing with their arms in a relaxed state.

An adjustment means, in the form of a head spacer 34, is attached to the head 28, and positioned in the bottom of the slot 30. The head spacer 34 is spring loaded and is adapted to vary the depth of the slot 30. The head spacer 34 is attached on its underside to a screw 33 which extends into the base 22 through a hole 37 in the bottom of the slot 30, and through the head plate 26. The screw 33 is fastened by a nut (not shown) on the inside of the housing underneath the head plate 26. Adjustment of the screw 33 and nut is used to manually set the desired height of the head spacer 34, and hence the gap between the head spacer 34 and the top of the slot 30. The nut is accessed by an access cover plate 35 which is bolted to the side of the base 22.

As best seen in FIG. 15, the apparatus 20 also includes a restraint means, in the form of a stainless steel locking pin 36, which projects from the head 28 transversely across the slot 30.

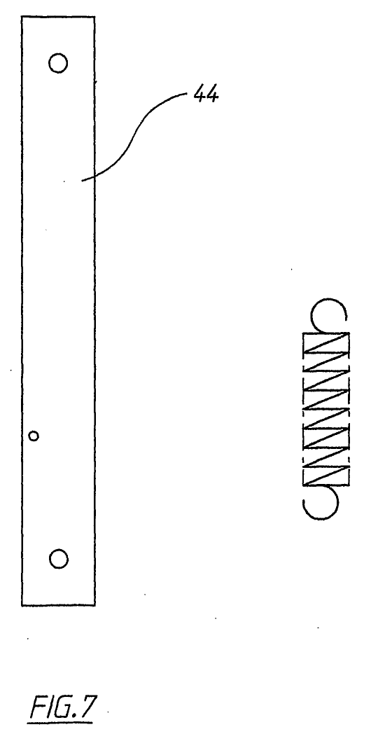

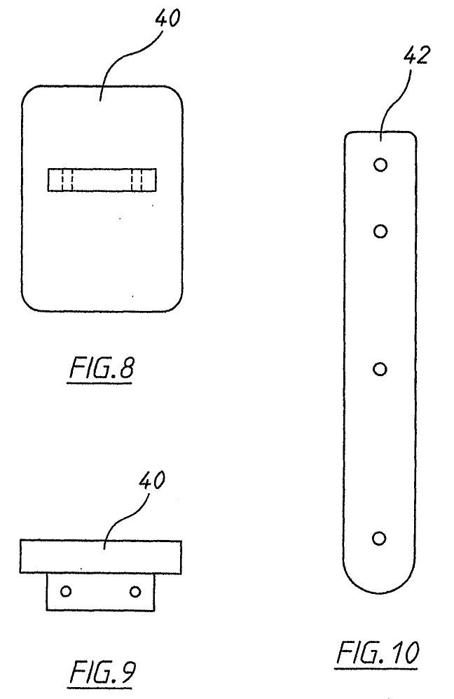

As best seen in FIGS. 8 and 9, a switch, in the form of a pedal 40, projects from the lower end of the base 22. The pedal 40 is connected to a pedal lever 42 (see FIG. 10) which is in turn attached to an inner bar 44 (see FIG. 7), disposed inside the tubular cavity of the base 22. The inner bar 44 is mechanically coupled to the locking pin 36, and the inner bar 44 is spring biased to close the locking pin 36 when no force is applied to the pedal 40.

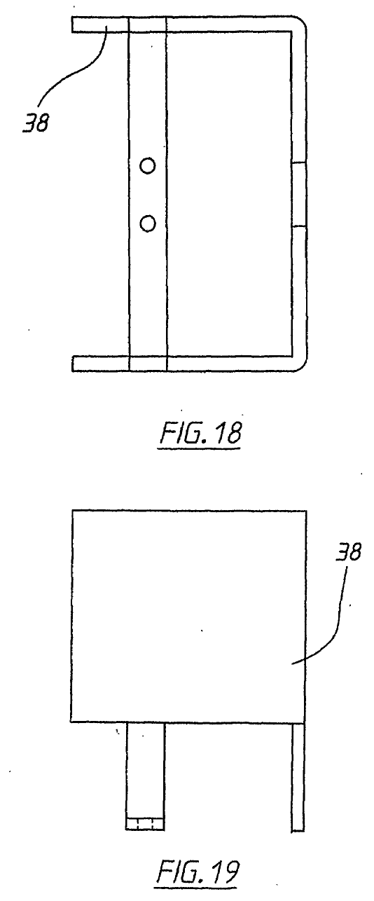

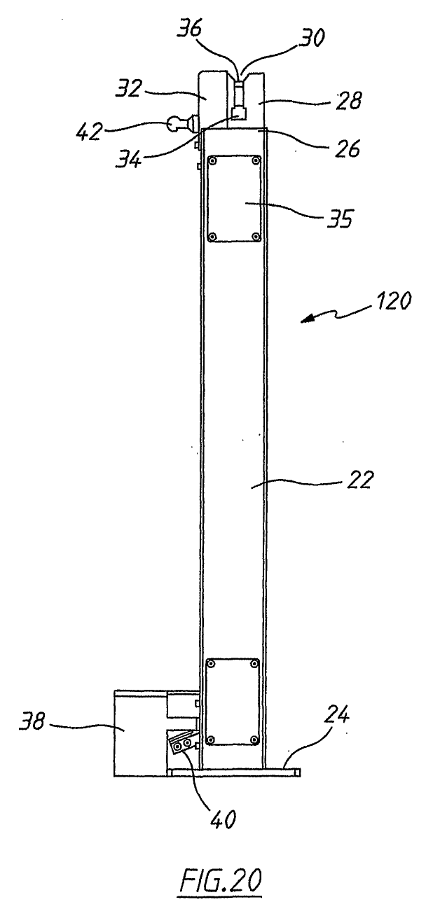

FIG. 1 shows a pedal shield 38, attached to the base plate 24 (see FIGS. 18 and 19 for detail). The pedal shield 38 covers the pedal 40 from one side and from above.

The operation of the apparatus 20 will now be described. As shown in FIG. 2, the apparatus 20 is fastened to the floor in a suitable location such as a police station, a prisoner processing area of a court, a prison, or other such facility. The apparatus 20 is rigidly bolted to the floor by a number of bolts which are received by holes 25 in the base plate 24.

To apply handcuffs to a detainee, a law enforcement official places one of his/her feet inside the pedal shield 38, and applies a force to the pedal 40, which is transmitted through the pedal lever 42, and through the inner bar 44. The force causes the locking pin 36 to retract into the head cover 32, and remain retracted whilst the pedal 40 is depressed. A pair of handcuffs (not shown) are then placed into the slot 30 with the central portion of the handcuffs (i.e. the chain or hinge region) being placed immediately beneath the locking pin 36, and above the head spacer 34.

The pedal 40 is then released and the spring loaded locking pin 36, slides back across the slot 30. This prevents the handcuffs from being removed from the apparatus 20 as the distance between the bottom of the slot 30 and the bottom of the pin 36 is less than the maximum circumferential diameter of each of the cuffs.

A detainee's wrist is then placed in one of the cuffs, and that cuff is then locked in the normal manner. Once the detainee has one arm restrained in the apparatus 20, he/she is unable to escape from the apparatus 20. The detainee's second arm is then placed in the second cuff which is also locked at that stage.

The detainee is now secured to the apparatus 20, and unable to escape, or use is their arms in an attack. The shield 38 over the pedal 40 prevents the detainee from accessing the pedal 40 to release the handcuffs from the apparatus 20, because he/she is standing on the opposite side of the apparatus 20.

The apparatus 20 can be used to cuff the detainee standing with their arms in front of their body or behind their back.

To remove handcuffs from a detainee, the pin 36 is retracted by depressing the pedal 40. The law enforcement officer then instructs the detainee to place the centre of the cuffs into the slot 30 of apparatus 20. The pedal 40 is then released, and the locking pin 36 closes in the manner outlined above such that the detainee is secured to the apparatus 20. The cuffs are removed one at a time, in a reverse process to that of securing a detainee. The detainee remains secured to the apparatus 20 until the second cuff is removed.

Different styles and brands of handcuffs have different dimensions, especially in the chain or hinged region between the cuffs. For example, the chain type cuffs have a smaller interconnecting region than hinged handcuffs. The head spacer 34 is used to adjust the space between the locking pin (when in the locked position) and the lowest portion of the slot 30. By removing the access cover 35, the law enforcement officer manually adjusts the height of the head spacer 34 to accommodate different sized handcuffs, by adjusting the internal screw.

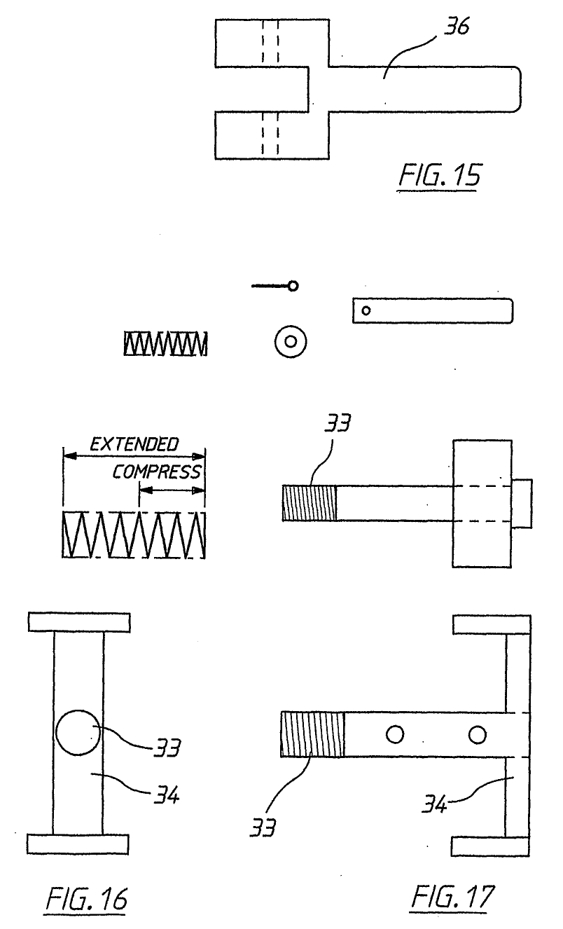

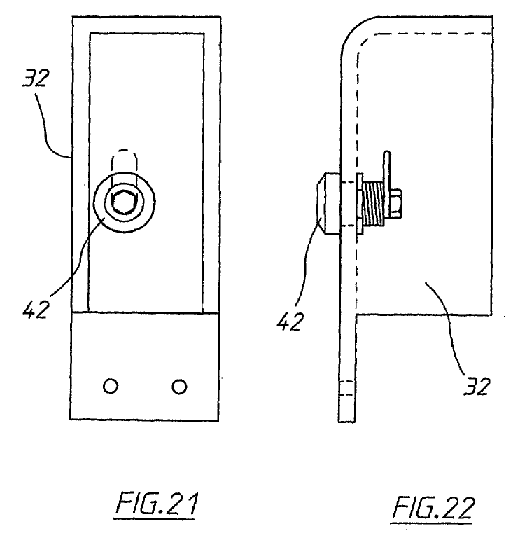

FIGS. 21 to 22 show a second embodiment of an apparatus for assisting in the application and removal of handcuffs, generally indicated by the reference numeral 120. The apparatus 120 is similar in construction to the apparatus 20 shown in FIGS. 1 to 19 and like reference numerals to those used in describing the first embodiment are used to indicate like features in the second embodiment. However, the apparatus 120 also includes a lock 42 in the head cover 32. The lock 42 is configured as a deadlocking device so that, once the key is removed from the lock 42, activating the pedal 40 will not retract the locking pin 36.

In another embodiment (not shown), the base 22 of the apparatus 20 is significantly shortened, and adapted to be securing to a bench top, wall or other such surface. In this embodiment the locking pin 36 is operated by a hand lever.

In another embodiment (not shown), the apparatus 20 includes a locking pin 36 located near the ground of the base 22 and adapted to receive and secure a pair of leg irons in a similar manner as outlined above. In one embodiment, the apparatus 20 has corresponding upper and lower locking pins to independently secure handcuffs and leg irons.

In a further embodiment (not shown), the vertical height of the base 22 is adjustable to accommodate the height of the detainee being secured. This prevents the detainee from extending his/her arms higher than is comfortable, or hunching over when secured to the apparatus 20.

In a further embodiment (not shown), the switch 40 is an electrical switch, and the restraint means 36 is a solenoid, or other such electrically driven locking device. In this embodiment the switch 40 can be mounted on the base 22, or alternatively mounted remote from the base 22. The solenoid is actuated by a signal transmission cable or a transmitted signal such as infra-red or the like.

An advantage of the apparatus 20 is that it ensures that a detainee is secured during a handcuff application procedure after only one cuff has been applied. Similarly, when a detainee is being released from handcuffs, the detainee is secure until the second cuff is removed.

A further advantage of the apparatus 20 is that it can be used to temporarily secure a detainee during processing, without requiring further supervision from a law enforcement officer.

Although the invention has been described with reference to specific examples, it will be appreciated by those skilled in the art that the invention may be embodied in many other forms.

1. An apparatus for assisting in the application and removal of handcuffs, the handcuffs including two cuffs joined by a central portion, the apparatus comprising: a base adapted for stationary fixing; a switch; and a means to selectively restrain the central portion of the handcuffs relative to the base within an opening through which the cuffs cannot pass, in response to activation of the switch.

2. The apparatus as claimed in claim 1, wherein the switch is associated with the base.

3. The apparatus as claimed in claim 1, wherein the apparatus includes an adjustment means adapted to selectively alter the size of the opening, thereby accommodating different sized handcuffs.

4. The apparatus as claimed in claim 1, wherein the restraint means includes a recess formed in the base.

5. The apparatus as claimed in claim 4, wherein the recess is a slot.

6. The apparatus as claimed in claim 5, wherein the restraint means includes a pin transversely extendable across the slot.

7. The apparatus as claimed in claim 6, wherein the adjustment means is adapted to alter the distance between the bottom of the slot and the pin.

8. The apparatus as claimed in claim 7, wherein the adjustment means is a spring biased plate.

9. The apparatus as claimed in claim 8, wherein the adjustment means includes a screw extendable into a hole in the bottom of the slot, the screw being engagable with a fastener inside the base.

10. The apparatus as claimed in claim 1, wherein the switch is a foot pedal.

11. The apparatus as claimed in claim 1, wherein the switch is in electrical communication with the restraint means.

12. The apparatus as claimed in claim 1, wherein the switch is shielded on one or more sides by a shield member.

13. The apparatus as claimed in claim 1, wherein the base is an elongate tube.

14. The apparatus as claimed in claim 13, wherein the tube is connectable at a first end to a base plate, and the restraint means is located at a second end of the tube.

15. The apparatus as claimed in claim 14, wherein the base plate includes a number of apertures adapted to receive fasteners for securing the apparatus.

16. The apparatus as claimed in claim 15, wherein the base has an internal cavity housing a bar, the bar mechanically connecting the foot pedal to the restraint means.

17. The apparatus as claimed in claim 16, wherein the bar is spring biased to close the restraint means when no force is applied to the pedal.

18. A method of applying handcuffs to a person, the handcuffs including two cuffs joined by a central portion, the method including the steps of: placing the central portion in an opening of a fixed apparatus; restricting the opening such that the central portion is restrained therein; placing one of the person's wrists in one of the cuffs and locking the cuff; and placing the person's other wrist in the other cuff and locking that cuff.

19. The method as claimed in claim 18, wherein the method includes the step of adjusting the size of the opening to correspond to the size of the central portion of the handcuffs.
